(19) United States
(12) Patent Application Publication
(10) Pub. No.: US 2023/0195451 A1
(43) Pub. Date: Jun. 22, 2023

(54) UNIFIED EXTENSIBLE FIRMWARE INTERFACE CONTROLLED UPDATE DEPLOYMENT IN AN INFORMATION HANDLING SYSTEM

(71) Applicant: Dell Products L.P., Round Rock, TX (US)

(72) Inventors: Shreya Shetty, Ujire (IN); Amit Pratap Singh, Bangalore (IN); Chirag Goyal, Bangalore (IN)

(21) Appl. No.: 17/554,976

(22) Filed: Dec. 17, 2021

(51) Int. Cl. G06F 8/654; G06F 9/4401; G06F 8/70

(52) U.S. Cl. CPC G06F 8/654; G06F 9/4411; G06F 9/4416; G06F 8/70

(57) ABSTRACT

An information handling system includes a processor, and a system memory device to store program instructions executable by the processor. The processor mounts a boot media, and executes the boot media. During the executing of the boot media, the processor fetches a firmware inventory for the information handling system and generates a firmware compliance report to the firmware inventory. Based on the firmware compliance report, the processor generates a firmware download capsule for firmware updates for the firmware inventory. Based on the firmware download capsule, the processor downloads supported firmware update packages.

### FIELD OF THE DISCLOSURE

This disclosure generally relates to information handling systems, and more particularly relates to a unified extensible firmware interface controlled update deployment system at an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system includes a processor, and a system memory device to store program instructions executable by the processor. The processor may mount a boot media, and execute the boot media. During the executing of the boot media, the processor may fetch a firmware inventory for the information handling system and generate a firmware compliance report to the firmware inventory. Based on the firmware compliance report, the processor may generate a firmware download capsule for firmware updates for the firmware inventory. Based on the firmware download capsule, the processor may download supported firmware update packages.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the present disclosure;

FIG. 2 is a block diagram of a portion of a system including an update server and an information handling system according to a specific embodiment of the present disclosure; and

FIGS. 3-6 are a flow diagram illustrating a method for updating firmware and drivers at an information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

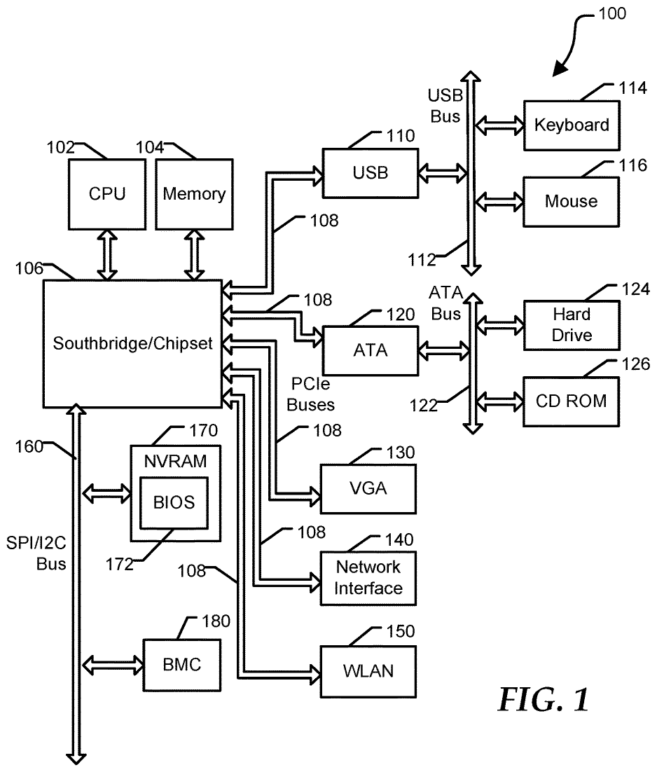

FIG. 1 illustrates an information handling system 100 including a processor 102, a memory 104, a chipset 106, a PCI bus 108, a universal serial bus (USB) controller 110, a USB 112, a keyboard device controller 114, a mouse device controller 116, a configuration database 118, an ATA bus controller 120, an ATA bus 122, a hard drive device controller 124, a compact disk read only memory (CD ROM) device controller 126, a video graphics array (VGA) device controller 130, a network interface controller (NIC) 140, a wireless local area network (WLAN) controller 150, a serial peripheral interface (SPI) bus 160, a flash memory device 170 for storing BIOS code 172, a trusted platform module (TPM) 180, and a baseboard management controller (EC) 190. EC 190 can be referred to as a service processor, and embedded controller, and the like. Flash memory device 170 can be referred to as a SPI flash device, BIOS non-volatile random access memory (NVRAM), and the like. EC 190 is configured to provide out-of-band access to devices at information handling system 100. As used herein, out-of-band access herein refers to operations performed without support of CPU 102, such as prior to execution of BIOS code 172 by processor 102 to initialize operation of system 100. In an embodiment, system 100 can further include a platform security processor (PSP) 174 and/or a management engine (ME) 176. In particular, an x86 processor provided by AMD can include PSP 174, while ME 176 is typically associated with systems based on Intel x86 processors.

PSP 174 and ME 176 are processors that can operate independently of core processors at CPU 102, and that can execute firmware prior to the execution of the BIOS by a primary CPU core processor. PSP 174, included in recent AMD-based systems, is a microcontroller that includes dedicated read-only memory (ROM) and static random access memory (SRAM). PSP 174 is an isolated processor that runs independently from the main CPU processor cores. PSP 174 has access to firmware stored at flash memory device 170. During the earliest stages of initialization of system 100, PSP 174 is configured to authenticate the first block of BIOS code stored at flash memory device 170 before releasing the x86 processor from reset. Accordingly, PSP 174 provides a hardware root of trust for system 100. ME 176 provides similar functionality in Intel-based systems. In another embodiment, EC 190 can provide aspects of a hardware root of trust. The root of trust relates to software processes and/or hardware devices that ensure that firmware and other software necessary for operation of an information handling system is operating as expected.

Information handling system 100 can include additional components and additional busses, not shown for clarity. For example, system 100 can include multiple processor cores, audio devices, and the like. While a particular arrangement of bus technologies and interconnections is illustrated for the purpose of example, one of skill will appreciate that the techniques disclosed herein are applicable to other system architectures. System 100 can include multiple CPUs and redundant bus controllers. One ore more components can be integrated together. For example, portions of chipset 106 can be integrated within CPU 102. In an embodiment, chipset 106 can include a platform controller hub (PCH). System 100 can include additional buses and bus protocols, for example I2C and the like. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as CPU 102, a programmable logic array (PLA), an embedded device such as a System-on-a-Chip (SoC), or other control logic hardware. Information handling system 100 can also include one or more computer-readable medium for storing machine-executable code, such as software or data.

BIOS code 172 can be referred to as a firmware image, and the term BIOS is herein used interchangeably with the term firmware image, or simply firmware. In an embodiment, BIOS 172 can be substantially compliant with one or more revisions of the Unified Extensible Firmware Interface (UEFI) specification. As used herein, the term Extensible Firmware Interface (EFI) is used synonymously with the term UEFI. The UEFI standard replaces the antiquated personal computer BIOS system found in some older information handling systems. However, the term BIOS is often still used to refer to the system firmware. The UEFI specification provides standard interfaces and interoperability guidelines for devices that together make up an information handling system. In particular, the UEFI specification provides a standardized architecture and data structures to manage initialization and configuration of devices, booting of platform resources, and passing of control to the OS. The UEFI specification allows for the extension of platform firmware by loading UEFI driver and UEFI application images. For example, an original equipment manufacturer can include customized or proprietary images to provide enhanced control and management of the information handling system 100. While the techniques disclosed herein are described in the context of a UEFI compliant system, one of skill will appreciate that aspects of the disclosed systems and methods can be implemented at substantially any information handling system having configurable firmware.

BIOS code 172 includes instructions executable by CPU 102 to initialize and test the hardware components of system 100, and to load a boot loader or an operating system (OS) from a mass storage device. BIOS code 172 additionally provides an abstraction layer for the hardware, i.e. a consistent way for application programs and operating systems to interact with the keyboard, display, and other input/output devices. When power is first applied to information handling system 100, the system begins a sequence of initialization procedures. During the initialization sequence, also referred to as a boot sequence, components of system 100 are configured and enabled for operation, and device drivers can be installed. Device drivers provide an interface through which other components of the system 100 can communicate with a corresponding device.

The storage capacity of SPI flash device 170 is typically limited to 32 MB or 64 MB of data. However, original equipment manufacturers (OEMs) of information handling systems may desire to provide advanced firmware capabilities, resulting in a BIOS image that is too large to fit in SPI flash device 170. Information handling system can include other non-volatile flash memory devices, in addition to SPI flash device 170. For example, memory 104 can include non-volatile memory devices in addition to dynamic random access memory devices. Such memory is referred to herein as non-volatile dual in-line memory module (NVDIMM) devices. In addition, hard drive 124 can include non-volatile storage elements, referred to as a solid state drive (SSD). For still another example, information handling system 100 can include one or more non-volatile memory express (NVMe) devices. Techniques disclosed herein provide for storing a portion of a BIOS image at one or more non-volatile memory devices in addition to SPI flash device 170.

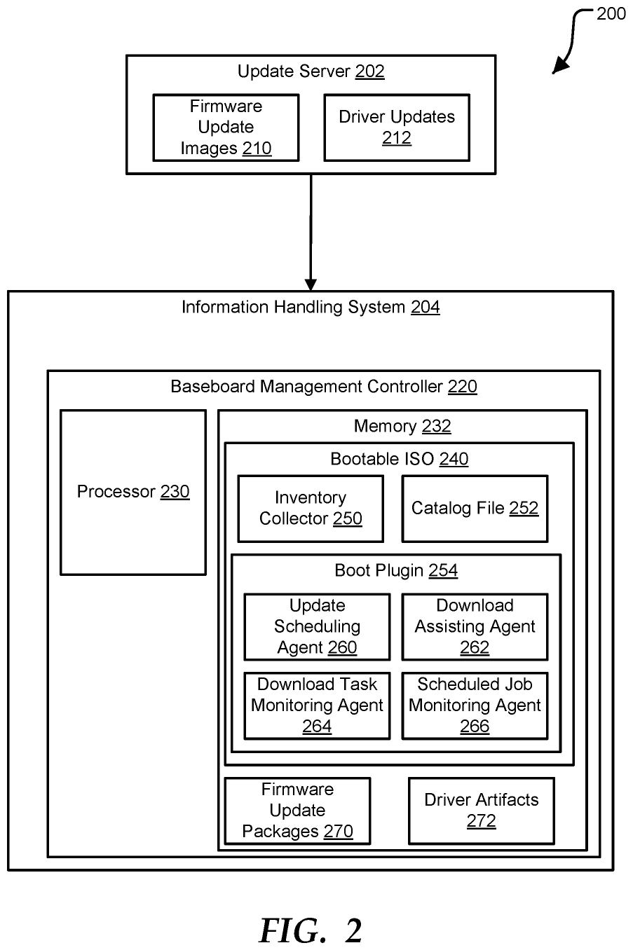

FIG. 2 illustrates a system 200 including an update server 202 and an information handling system 204 according to a particular embodiment of the present disclosure. In an example, information handling system 204 may be substantially similar to information handling system 100 of FIG. 1. Information handling system 204 may be any suitable device including, but not limited to, a server in a data center. Update server 202 may provide a variety of updates to information handling system 204, such as firmware update images 210 and driver updates 212. In an example, one or more of firmware update images 210 may have dependencies with one or more driver updates 212, such that particular firmware updates should be performed along with particular driver updates. Information handling system 204 includes a baseboard management controller 220, which in turn includes a processor 230 and a memory 232. In an example, memory 232 may be any suitable type of memory including, but not limited to a non-volatile memory, such as SPI flash device 170 of FIG. 1. In certain examples, update server 202, information handling system 204, and baseboard management controller 220 may each include additional components over those shown in FIG. 2 without varying from the scope of this disclosure.

In an example, information handling system 204 may be only one of multiple information handling systems in system 200. For example, system 200 may be a data center with any number of server racks and each server rack may have multiple information handling systems or servers. In certain examples, system 200 may be any size of a data center, such as a small-scale data center, a medium-scale data center, and a large-scale data center. The information handling systems, such as information handling system 204, within system 200 may communicate with update server 202 to perform automated solutions and utilities to receive and install both firmware and driver updates. System 200 may include any suitable number of automated solutions including, but not limited to, Platform Specific Bootable ISO (PSBI), and System Update Utility (SUU).

In previous information handling systems, a platform specific ISO may be provided to each of the information handling systems in the system having a particular platform. The previous information handling systems may download and maintain multiple firmware images corresponding to various platforms if the system has multiple platforms within the system. The platform specific ISO may include a boot media carrying an entire repository specific to that particular platform, such that the previous information handling system may attempt an update of all components applicable to a model. In this situation, previous information handling system may download update packages (UPs) that are not relevant to the information handling system. The downloading of unneeded UPs, may generate false errors in the information handling system, and may result in consumption of unnecessary data and time without facilitating driver updates on the information handling system. Thus, information handling system 204 may be improved by preforming updates for both the firmware and associated drivers by downloading only the particular firmware and driver updates relevant to the information handling system. Information handling system 204 may be further improved by a bootable ISO 240 not including a repository of all available firmware updates and operating system driver updates.

In an example, bootable ISO 240 may be a customized boot media utilizing UEFI functionalities to aid a majority of the operations performed during the update process, followed by discrete procedures to deploy different types of updates. Bootable ISO 240 may be received at information handling system 204 and stored in memory 232. In an example, bootable ISO 240 may include any suitable code to assist the firmware and driver updates within information handling system 204. For example, code within bootable ISO 240 may include, but is not limited to, an inventory collector 250, a catalog file 252, and a boot plugin 254. Catalog file 252 may include metadata for available update packages in update server 202. In certain examples, boot plugin 254 may include one or more agents to be executed by processor 230, such as an update scheduling agent 260, a download assisting agent 262, a download task monitoring agent 264, a scheduled job monitoring agent 266, or the like.

In certain examples, agents 260-266 may be executed in a substantially concurrent manner and coordinate with each other. Execution of agents 260-266 may begin from processor 230 reading and EFI system partition (ESP) table to fetch essential details. As described in detail below, agents 260-266 may generate compliance reports, segregate the type of updates, consume UEFI networking feature to enforce update package downloads, store downloaded artifacts 272, and choose/schedule the appropriate update deployment techniques.

In an example, information handling system 204 may be initially booted in response to a mounting operation of bootable ISO 240 within memory 232. After bootable ISO 240 being mounted, boot plugin 254 may boot with a live OS of processor 230, which in turn may automatically trigger agents 260-266 to employ multiple jobs. FIG. 2 will be discussed with respect to operations performed by agents 260-266. One of ordinary skill in the art would recognize that operations performed by agents 260-266 are operations performed by processor 230 while executing code within the agents. In response to boot plugin 254 being booted, update scheduling agent 260 may take control of the boot operations and begin executing inventory collector 250 to fetch firmware inventory within information handling system 204. Based on inventory collector 250 obtaining required details for the firmware inventory, processor 230 may generate a firmware compliance report. In an example, the firmware compliance report may be generated in any suitable manner including, but not limited to, processor 230 comparing the inventory details for the firmware of information handling system 204 against catalog file 252. In this example, the firmware compliance report may include a list of firmware updates in catalog file 252 that correspond with firmware of information handling system 204.

In certain examples, the generation of the firmware compliance report may launch execution of download assisting agent 262. In an example, download assisting agent 262 may collect information from the firmware compliance report about applicable firmware updates for a given platform of information handling system 204. Download assisting agent 262 may then access a source location of the corresponding packages from catalog file 252. Download assisting agent 262 may consolidate the gathered data and utilize the consolidated data to generate a firmware download capsule. In certain examples, the firmware download capsule may be pushed to UEFI of information handling system 204 to initiate download tasks for all the supported Update Package(s) (UPs) 270 from their respective locations, such as storage locations of firmware update images 210 in update server 202. In an example, the locations of UPs 270 may be determined based on the source locations obtained by download assisting agent 262 from catalog file 252. The source locations may be included in the firmware download capsule. In certain example, UPs 270 may be downloaded in any suitable format including, but not limited to, an .EXE format. In an example, UPs 270 may be downloaded via a networking feature in the UEFI firmware of information handling system 204. UPs 270 may be utilized by processor 230 of BMC 220 to perform firmware update jobs as will be described below.

In an example, as download assisting agent 262 is performing the operations described above, update scheduling agent 260 may perform one or more operations in a substantially parallel manner. For example, update scheduling agent 260 may read the EFI partition table to identify the operating system (OS), if any, being executed within information handling system 204, such as by processor 230. If a determination is made that components of information handling system 204 are utilizing an OS, update scheduling agent 260 may determine the type of OS. If the identified OS is a particular type of OS, such as Windows™, a driver updates servicing agent may be triggered, which in turn may recognize the OS architecture and other details associated with the OS. In an example, the driver updates servicing agent may read the firmware inventory for information handling system 204. In certain examples, the firmware inventory may be based on the supported drivers may be mapped against catalog file 252. For example, the driver updates servicing agent may collect the device details from the firmware components and search all applicable device details in catalog file 252 against the driver UPs 270. In an example, this comparison may be utilized to identify the applicable driver updates information handling system 204.

In response to the applicable driver updates being identified, download assisting agent 262 may initiate a download task for driver update packages 212. In an example, download assisting agent 262 may initiate the download task in any suitable manner including, but not limited to, by creating and pushing a driver download capsule to the UEFI of information handling system 204. In certain examples, the firmware download capsule and the driver download capsule may be separate, such that different download bundles job identifications may be maintained for firmware updates 210 and driver updates 212. In response to the download jobs being initiated, download task monitoring agent 264 may continuously monitor the different download jobs. In an example, if no driver updates are needed, processor 230 may continue with firmware updates.

In an example, download task monitoring agent 264 may determine whether each of the driver download jobs are successful. For successful downloads, artifacts 272 for the driver download may be stored inside UEFI partition of information handling system 204. In certain examples, the downloaded contents for the driver updates may be saved inside a live OS temporary drive of information handlings system 204 or a required space acquired from memory 232. In response to a download failure, the failed download job may be retriggered any suitable number of times. When a limit of the number of retries is exceeded, the corresponding job may be marked as “FAILED” with a relevant error message. Update scheduling agent 260 may hand-off the concerned update packages to BMC 220 and schedule a job inside the BMC for firmware flash.

Scheduled job monitoring agent 266 may continuously poll the job status to ensure the firmware update jobs are successfully scheduled. In an example, the agent handling driver updates may retrieve the saved driver artifacts 272 and encapsulate them into a wrapper along with an update script and a header to identify device and content. Update scheduling agent 260 may initiate a job inside UEFI to copy the driver wrappers into a system boot partition in order to schedule a driver update job. Scheduled job monitoring agent 266 would continuously poll UEFI for the scheduled job status. Once all the job completions are acknowledged, information handling system 204 may perform an automatic reboot. In an example, a user may refer to UEFI logs for performed job statuses.

When the automatic reboot of information handling system is operational, processor 230 of BMC 220 may perform firmware update jobs via any suitable manner to implement firmware updates. For example, processor 230 may utilize UPs 270 stored in UEFI firmware of information handling system 204 to perform the firmware updates. After successful firmware updates, information handling system 204 may boot to OS and the boot partition may automatically trigger the driver update jobs scheduled inside UEFI. In response to the OS, such as Windows™, providing the status of driver updates, the agent may clear the boot partition in memory 232 and all the update related jobs from the partition table and exit from the update job.

As described above, utilization of bootable ISO 240 may improve information handling system 204. For example, bootable ISO 240 may enable information handling system 204 to perform a majority of the firmware and driver updates in an UEFI mode and prevent the information handling system from downloading offline pre-bundled contents, which in turn may reduce a risk of any external attacks on the information handling system. In an example, a single utility bootable ISO 240 may be utilized across all supported platforms in system 200. In certain examples, changes in bootable ISO 240 may be aligned with that of catalog file 252 which may enable faster availability of latest firmware and driver update contents.

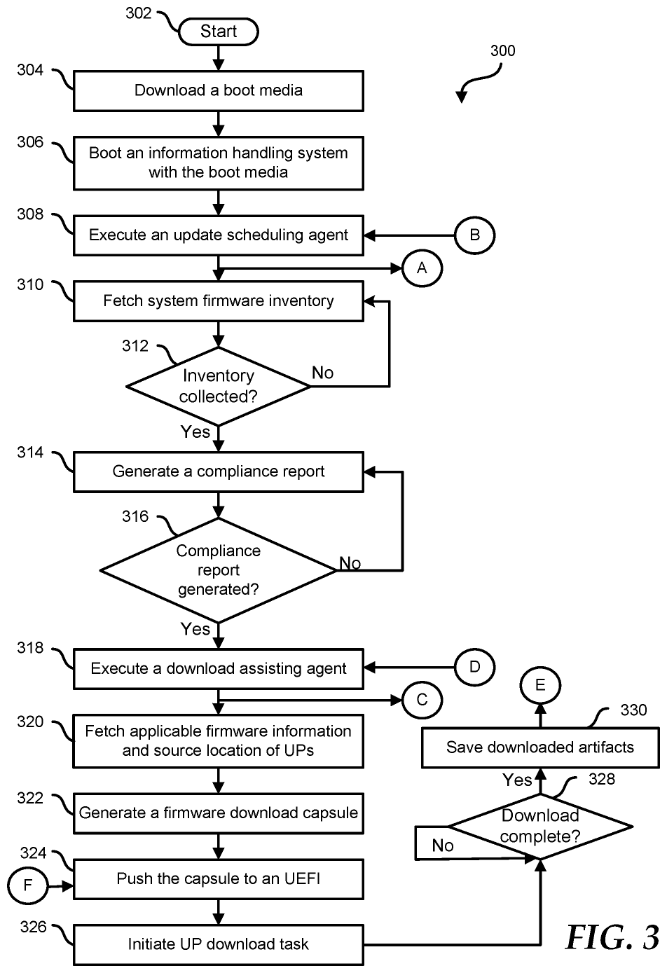

FIGS. 3-6 illustrate a flow diagram of a method 300 for updating firmware and drivers at an information handling system according to at least one embodiment of the present disclosure, starting at block 302. It will be readily appreciated that not every method step set forth in this flow diagram is always necessary, and that certain steps of the methods may be combined, performed simultaneously, in a different order, or perhaps omitted, without varying from the scope of the disclosure. FIG. 3 may be employed in whole, or in part, by information handling system 100 depicted in FIG. 1, information handling system 204 depicted in FIG. 2, or any other type of system, controller, device, module, processor, or any combination thereof, operable to employ all, or portions of, the method of FIG. 3.

At block 304, a boot media is downloaded. In an example, the boot media may be any suitable bootable ISO, such as a customized boot media utilizing UEFI functionalities to aid a majority of the operations performed during the update process, followed by discrete procedures to deploy different types of updates. The boot media may be stored in a memory of the information handling system. In an example, the bootable ISO may include any suitable code to assist the firmware and driver updates within information handling the system.

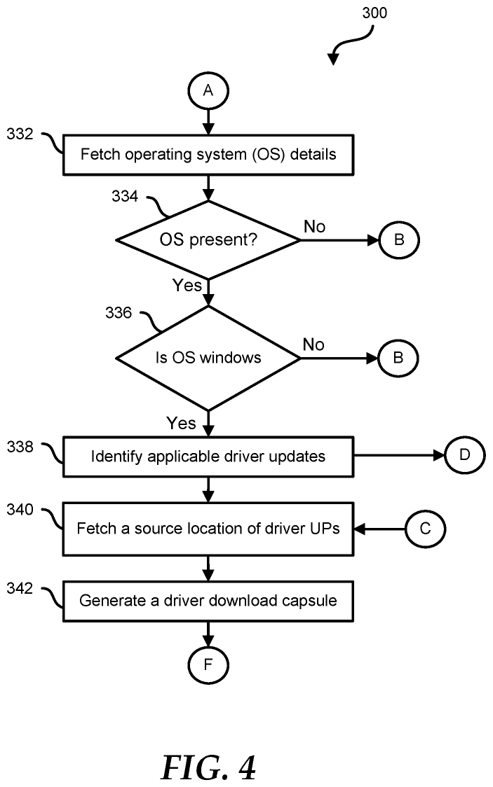

At block 306, the information handling system is booted from the boot media. In an example, information handling system may be initially booted from the boot media in response to a mounting operation of bootable ISO within memory. At block 308, an update scheduling agent is executed. One of ordinary skill in the art would recognize that operations performed by the update scheduling agent being executed may be operations performed by a processor of the information handling system. At block 310, a system firmware inventory is fetched or determined. In response to the update scheduling agent being executed, operations of method 300 illustrated in FIG. 4 may be performed in a substantially parallel execution with the operations illustrates in FIG. 3. For example, while the system firmware inventory is being fetched, the flow may also continue as described below at block 332 of FIG. 4.

At block 312, a determination is made whether the firmware inventory has been collected or fetched. In an example, the firmware inventory may be collected in any suitable manner including, but not limited to, an inventory collector obtaining required details for the firmware inventory. In response to the firmware inventory being collected, a compliance report is generated at block 314. In an example, the firmware compliance report may be generated in any suitable manner including, but not limited to, a processor comparing the inventory details for the firmware of the information handling system against a catalog file. In this example, the firmware compliance report may include a list of firmware updates in the catalog file that correspond with the firmware of the information handling system.

In response the generation of the firmware compliance report, a download assisting agent may be executed at block 318. While the download assisting agent is being executed, the flow continues at both block 340 and block 320. At block 320, applicable firmware information and source locations for UPs are fetched or collected. In an example, the download assisting agent may collect information from the firmware compliance report about applicable firmware updates for a given platform of information handling system. The download assisting agent may then access a source location of the corresponding packages from a catalog file. At block 322, a firmware download capsule is generated. In an example, the download assisting agent generate the firmware download capsule in any suitable manner including, but not limited to, consolidating the gathered data and utilizing the consolidated data to generate the firmware download capsule.

At block 324, the firmware download capsule may be pushed to an UEFI of information handling system. At block 326, UP download task are initiated. In an example, the pushing of the firmware download capsule to the UEFI may initiate download tasks for all the supported UPs from their respective locations, such as storage locations of firmware update images in an update server. In an example, the locations of UPs may be determined based on the source locations obtained by the download assisting agent from the catalog file. The source locations may be included in the firmware download capsule. In certain examples, the UPs may be downloaded in any suitable format including, but not limited to, an .EXE format. In an example, the UPs may be downloaded via a networking feature in the UEFI firmware of information handling system. At block 328, a determination is made whether the downloads are completed. In response to the downloads being completed, downloaded artifacts are saved at block 330.

Referring now to FIG. 4, OS details for the information handling system are fetched or retrieved at block 332. As stated above, blocks 332-342 may be performed in a substantially parallel as blocks 310-330. In an example, the update scheduling agent may read the EFI partition table to identify the OS, if any, being executed within the information handling system, such as by a processor. At block 334, a determination is made whether an OS is present within the information handling system. If an OS is not present, the flow continues as stated above at block 308. If an OS is present, a determination is made whether the OS is a particular type of OS, such Windows™ at block 336. If the OS is not the particular type of OS, the flow continues as stated above at block 308. If the OS is the particular type of OS, applicable driver updates are identified at block 338. In an example, a driver updates servicing agent may collect the device details from the firmware components and search all applicable device details in the catalog file against the driver UPs. In an example, this comparison may be utilized to identify the applicable driver updates information handling system. After the applicable driver updates have been identified, the flow continues at block 318 and a source location of driver UPs are fetched at block 340. At block 342, driver download capsules are generated. In an example, the download assisting agent may initiate a download task for driver update packages pushing a driver download capsule to the UEFI of information handling system at block 324.

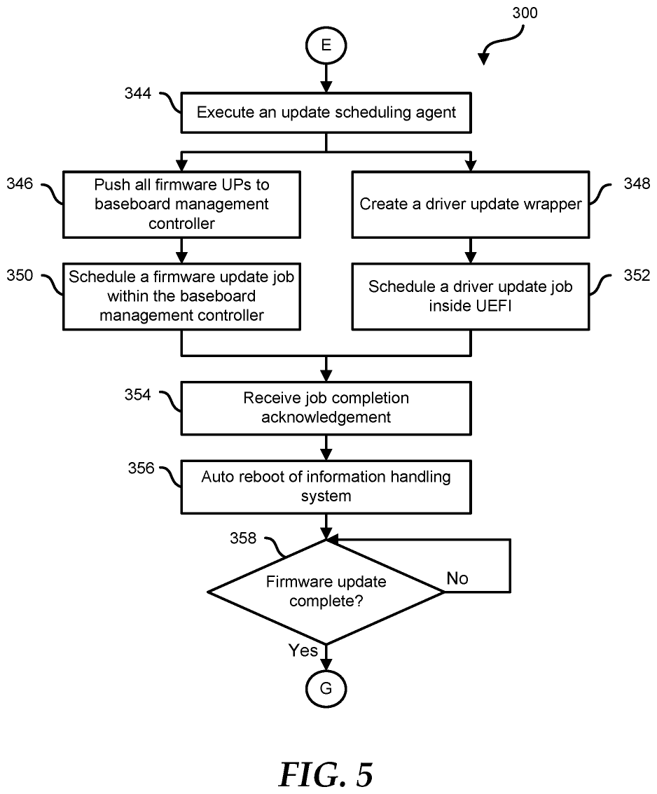

Referring now to FIG. 5, after the artifacts are saved at block 330, an update scheduling agent is executed at block 344. While the update scheduling agent is being executed, the operations of blocks 346-358 may be performed. At block 346, all firmware UPs are pushed to a baseboard management controller (BMC). At block 348, a driver update wrapper is created. In an example, the agent handling driver updates may retrieve the saved driver artifacts and encapsulate them into a wrapper along with an update script and a header to identify device and content. In certain examples, blocks 346 and 348 may be performed in a substantially parallel manner. At block 350, a firmware update job is scheduled within the BMC. At block 352, a driver update job is scheduled within the UEFI. The update scheduling agent may initiate a job inside UEFI to copy the driver wrappers into a system boot partition in order to schedule a driver update job. In an example, blocks 350 and 352 may be performed in a substantially parallel manner.

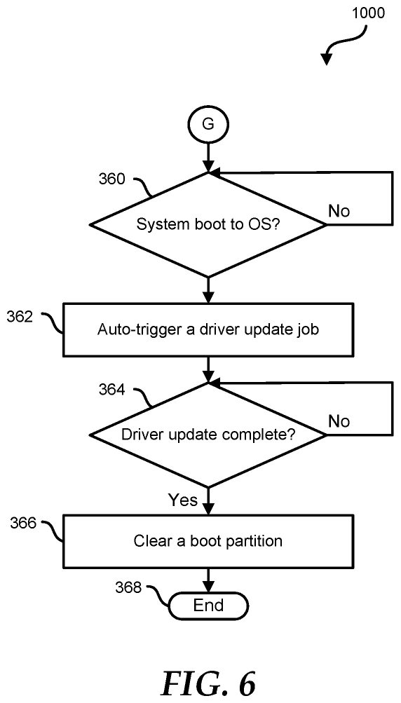

At block 354, a job completion acknowledgement is received. At block 356, an automatic reboot of the information handling system may be performed. At block 358, a determination is made whether the firmware update is complete. In an example, a processor of the BMC may perform firmware update jobs via any suitable manner to implement firmware updates. For example, the processor may utilize the UPs stored in UEFI firmware of the information handling system to perform the firmware updates. In response to the firmware update being completed, the flow continues at block 360 of FIG. 6.

Referring now to FIG. 6, a determination is made whether the information handling system has booted to the OS at block 360. In response to the information handling system booting to the OS, a driver update job is automatically triggered at block 362. At block 364, a determination is made whether the driver updates are completed. In response to the driver updates being completed, a boot partition including the driver update jobs is cleared at block 366 and the method ends at block 368. In an example, the agent may clear the boot partition in memory and all the update related jobs from the partition table and exit from the update job.

Referring back to FIG. 1, the information handling system 100 can include a set of instructions that can be executed to cause the information handling system to perform any one or more of the methods or computer based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 can include a disk drive unit and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at system 100, and/or within the processor 102 during execution by the information handling system 100. The system memory 104 and the processor 102 also may include computer-readable media. A network interface device (not shown at FIG. 1) can provide connectivity to a network, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
mounting a boot media;
executing, by a processor of an information handling system, the boot media; and
during the executing of the boot media:
fetching a firmware inventory for the information handling system;
generating a firmware compliance report to the firmware inventory;
based on the firmware compliance report, generating a firmware download capsule for firmware updates for the firmware inventory; and
based on the firmware download capsule, downloading supported firmware update packages.

2. The method of claim 1, further comprising:
detecting an operating system of the information handling system;
in response to the operating system being a particular type of operating system, determining one or more supported drivers in the operating system;
determining driver updates for the information handling system;
creating a driver download capsule based on the driver updates; and
initiating a download task for driver packages based on the driver download capsule.

3. The method of claim 2, wherein the determining of the driver updates, the method further comprises:
mapping the supported drivers against a catalog file in the boot media to collect device details for the firmware components of the information handling system; and
comparing the collected device details against driver update packets to identify the driver updates for the information handling system.

4. The method of claim 2, wherein the initiating of the download task for the driver packages, the method further comprises:
pushing a driver download capsule to an Unified Extensible Firmware Interface of the information handling system.

5. The method of claim 4, further comprising:
in response to a successful download, storing the driver download capsule to a first data storage device in the information handling system.

6. The method of claim 5, wherein the first data storage device is a Serial Peripheral Interface (SPI) flash memory device.

7. The method of claim 5, further comprising:
in response to detecting a failure of a download, retriggering a download job;
in response to a number of retries of the download job exceeding a threshold number, marking the download job as failed.

8. The method of claim 2, wherein a first download bundle is maintained for the supported firmware update packages and a second download bundle is maintained for the driver packages.

9. The method of claim 1, wherein the boot media includes a catalog file including metadata for update packages and a boot plugin agent.

10. An information handling system comprising:
a processor;
a system memory device to store program instructions executable by the processor to:
mount a boot media;
execute the boot media; and
during the executing of the boot media, the processor to:
fetch a firmware inventory for the information handling system;
generate a firmware compliance report to the firmware inventory;
based on the firmware compliance report, generate a firmware download capsule for firmware updates for the firmware inventory; and
based on the firmware download capsule, download supported firmware update packages.

11. The information handling system of claim 10, wherein the processor further to:
detect an operating system of the information handling system;
in response to the operating system being a particular type of operating system, determine one or more supported drivers in the operating system;
determine driver updates for the information handling system;
create a driver download capsule based on the driver updates; and
initiate a download task for driver packages based on the driver download capsule

12. The information handling system of claim 11, wherein the determination of the driver updates, the processor further to:
map the supported drivers against a catalog file in the boot media to collect device details for the firmware components of the information handling system; and
compare the collected device details against driver update packets to identify the driver updates for the information handling system.

13. The information handling system of claim 12, wherein the initiation of the download task for the driver packages, the processor further to:
push a driver download capsule to an Unified Extensible Firmware Interface of the information handling system.

14. The information handling system of claim 13, wherein the processor further to:
in response to a successful download, store the driver download capsule to a first data storage device in the information handling system.

15. The information handling system of claim 14, wherein the first data storage device is a Serial Peripheral Interface (SPI) flash memory device.

16. The information handling system of claim 14, the first firmware instructions to
in response to detecting a failure of a download, retrigger a download job;
in response to a number of retries of the download job exceeding a threshold number, mark the download job as failed.

17. The information handling system of claim 11, wherein a first download bundle is maintained for the supported firmware update packages and a second download bundle is maintained for the driver packages.

18. The information handling system of claim 10, wherein the boot media includes a catalog file including metadata for update packages and a boot plugin agent.

19. A method comprising:
mounting a boot media, wherein the boot media includes a catalog file including metadata for update packages and a boot plugin agent;
executing, by a processor of an information handling system, the boot media; and
during the executing of the boot media:
fetching a firmware inventory for the information handling system;
generating a firmware compliance report to the firmware inventory;
based on the firmware compliance report, generating a firmware download capsule for firmware updates for the firmware inventory;
based on the firmware download capsule, downloading supported firmware update packages;
detecting an operating system of the information handling system;
in response to the operating system being a particular type of operating system, determining one or more supported drivers in the operating system;
determining driver updates for the information handling system;
creating a driver download capsule based on the driver updates; and
initiating a download task for driver packages based on the driver download capsule.

20. The method of claim 19, further comprising:
mapping the supported drivers against the catalog file in the boot media to collect device details for the firmware components of the information handling system; and
comparing the collected device details against driver update packets to identify the driver updates for the information handling system.
